(19) United States
(12) Patent Application Publication
(10) Pub. No.: US 2026/0044829 A1
(43) Pub. Date: Feb. 12, 2026

(54) METHOD AND ONLINE ADAPTIVE TESTING SYSTEM FOR IPSATIVE ASSESSMENT OF CAREER INTEREST

(71) Applicant: Xuelan QIU, Kennedy Town (HK)

(72) Inventor: Xuelan QIU, Kennedy Town (HK)

(21) Appl. No.: 19/297,003

(22) Filed: Aug. 12, 2025

(30) Foreign Application Priority Data
Aug. 12, 2024 (HK) 32024095423.2

(51) Int. Cl. G06Q 10/1053; G06F 17/18; G06Q 10/0639

(52) U.S. Cl. CPC G06Q 10/1053; G06F 17/18; G06Q 10/06393

(57) ABSTRACT

Existing methods and systems for career interest assessment are neither efficient nor robust against response biases. The present disclosure proposes a method and an online adaptive testing system to assess users' career interest levels using ipsative multidimensional forced-choice (MFC) items. The method selects and administers items tailored to each user's unique career interest level while controlling the exposure of items. This approach provides an efficient solution for assessing career interests. By using MFC items, the method effectively reduces response biases and the potential for faking, which are commonly associated with career interest assessments. The method is delivered through an online adaptive testing system to enable real-time, efficient, and accurate assessment of career interests for users.

### TECHNICAL FIELD

The non-limiting and example embodiments of the present disclosure generally relate to the field of information technology, and specifically to the method and online adaptive testing system for ipsative assessment of users' career interest level.

### BACKGROUND

This section introduces the backgrounds that may facilitate a better understanding of the present disclosure. Accordingly, the statements of this section are to be read in this light and are not to be understood as explicit admissions about what is in the prior art or what is not in the prior art.

### Introduction to Career Interest Assessment

Career interest assessment is a systematic process designed to help individuals identify their natural preferences and inclinations towards different types of work. The assessment guides people in making informed career choices by aligning their interests with suitable job roles. In the realm of career planning, it plays a crucial role in fostering self-awareness, ensuring that individuals can pursue professions that truly resonate with their interests.

### 2. Overview of the Holland Career Interest Assessment

Dr. John L. Holland's career interest theory, a foundational concept in career counseling, posits that most individuals can be categorized into one of six career types based on their interests: Realistic (R), Investigative (I), Artistic (A), Social (S), Enterprising (E), and Conventional (C). Each career type is associated with a distinct set of job characteristics and work environments. The Holland Career Interest Assessment, developed from this theory, has a long-standing history and is widely recognized for its effectiveness in vocational guidance.

To participate in the Holland Career Interest Assessment, individuals typically complete a self-report paper-and-pencil or online questionnaire that gauges their preferences across various activities and work styles. The results are then used to generate a profile that indicates the individual's most dominant interest areas. This profile can be compared with the interest codes of various occupations to identify potential careers.

Examples of online tests include the Holland Code (RIASEC) Test (https://openpsychometrics.org/tests/RIASEC/) and the Holland Code Career Quiz (https://www.truity.com/test/holland-code-career-test). It is important to note that these tests, although administered online, present the same set of items to each test users and ask them to complete within a fixed time duration. Essentially, they are digital version of traditional paper-and-pencil career interests tests. Unlike their traditional counterparts, these online tests offer greater convenience as they do not require users to be present at a specific time and place. However, they do not enhance testing efficiency, as all users still undergo the same set of items and spend almost the same amount of time.

Moreover, these existing testing systems typically use Likert-type items which are known to be vulnerable to response biases such as the inclination towards socially desirable responses. The response biases are common in interest assessments, especially in settings where the career interest assessments are used for pre-employment screening.

In conclusion, career interest assessments, like the Holland Career Interest Assessment, offer individuals a valuable tool to discover and pursue careers that match their interests. By utilizing these assessments, individuals can confidently navigate their career journeys, ensuring that their work is not just a means of livelihood but also a source of satisfaction and fulfillment. Therefore, it is advisable for people to undergo a career interest assessment to pave the way for a successful and rewarding professional life.

### SUMMARY

As discussed above, the inventors of the present disclosure have identified that the existing methods and systems for career interest assessment are neither efficient nor robust against response biases. Thanks to the rapid advancement of computer technology and psychometrics testing theory, they have conceived a solution to address, or at least alleviate, these problems. The main objects of the solution include:
1. To make the assessment of career interests more efficient and convenient,
2. To effectively prevent response biases in the assessment of career interests, and
3. To develop an online system that can realize the advantages in points 1 and 2 for the assessment of career interests.

According to the first aspect of the solution, the object is achieved by utilizing Computerized Adaptive Testing (CAT) technology that harnesses the power of the computer technology and sophisticated psychometric models and algorithms to offer assessments that can be administered online and adaptively. The process of CAT comprises the following steps: (1) Building an item pool with a large bank (e.g., several hundred) of high-quality items and calibrating (i.e., pre-testing) these items on a representative sample of users; (2) Staring the CAT procedure by setting initial values (e.g., 0) for the entry level of the career interest for every user; (3) Selecting a new item from the item pool that is tailored to the user's career interest level, while simultaneously controlling the exposure of items; (4) Updating the career interest level according to the user's response to the selected item; (5) Determining whether the number of administered items has reached a specific test length. If not, repeating steps 3 and 4; and (6) Outputting the career interest level as the result of the assessment. Steps 1 and 2 take place before the item administration while the remaining steps are the measurement procedure for an individual user. Detailed steps are provided in the “DETAILED DESCRIPTION” section.

By selecting items tailored to each individual's career interests levels and thereby saving users' times on irrelevant items, the present disclosure offers an efficient approach to assess career interests. By adopting a random component in the item selection procedure, the present disclosure controls the exposure rate of items to effectively use the item pool, prevents over-exposure or potential leakage of items, and thus ensures the security of the testing process.

Utilizing the internet technology, the present disclosure further streamlines the CAT process, facilitating efficient administration and instant score reporting. Hence, it allows users to test their career interests using the reputable Holland Career Interests inventory, anytime and anywhere, with significantly reduced testing time and immediate results.

According to the second aspect of the solution, the objective is achieved by using ipsative multidimensional forced-choice (MFC) items in the assessment of career interests. An MFC item includes two statements similar in social desirability, each relating to one of the six career types, with K choices reflecting K preference categories between them. When attending the test, users are asked to choose one of the K choices (that is the name ‘forced-choice’ comes from). Unlike Likert-type items used in the existing systems, MFC items can effectively reduce response biases or faking, as detailed in the “DETAILED DESCRIPTION” section. For conciseness, the term “item” refers specifically to “MFC item” in the following, unless otherwise stated.

According to the third aspect of the solution, the objective is achieved through an online system that administers the ipsative career interest assessment, in which items tailored to a user's career interest levels are selected and administered to the user. The system includes a computer program product comprising instructions that implement the algorithms and steps described in the first aspect of the solution, a processor that executes the computer program, and memory and other computer-readable media that store instructions, user responses, and other information collected during the career interest testing. All these methods are delivered from the secure, highly scalable, cost-effective, and manageable platform, namely, the Online Adaptive Testing System for Ipsative Holland Career Interests (IHCI-CAT).

### BRIEF DESCRIPTION OF THE DRAWINGS

The above and other aspects, features, and benefits of the present disclosure will become more fully apparent from the following detailed description with reference to the accompanying drawings, in which similar reference numerals or letters are used to designate elements alike or equivalent. The drawings are illustrated to facilitate better understanding of the embodiments of the disclosure and are not necessarily drawn to scale, in which:

FIG. 1 illustrates a flowchart of the method according to the present disclosure;

FIG. 2 shows an example MFC item according to the present disclosure;

FIG. 3 shows example formation of the item pool according to the present disclosure;

FIG. 4 shows an example report produced from the testing system according to the present disclosure;

FIG. 5 is a schematic block diagram of a system according to the present disclosure;

FIG. 6 is another schematic block diagram of a system according to the present disclosure.

### DETAILED DESCRIPTION

Embodiments herein will be described more fully hereinafter with reference to the accompanying drawings. The embodiments herein may, however, be embodied in many different forms and should not be construed as limiting the scope of the appended claims.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Also, use of ordinal terms such as “first,” “second,” “third,” etc., herein to modify an element does not by itself connote any priority, precedence, or order of one element over another or the temporal order in which acts of a method are performed, but are used merely as labels to distinguish one element having a certain name from another element having a same name (but for use of the ordinal term) to distinguish the elements.

Unless otherwise defined, all terms (including technical and scientific terms) used herein have the same meaning as commonly understood. It will be further understood that terms used herein should be interpreted as having a meaning that is consistent with their meaning in the context of this specification and the relevant art and will not be interpreted in an idealized or overly formal sense unless expressly so defined herein.

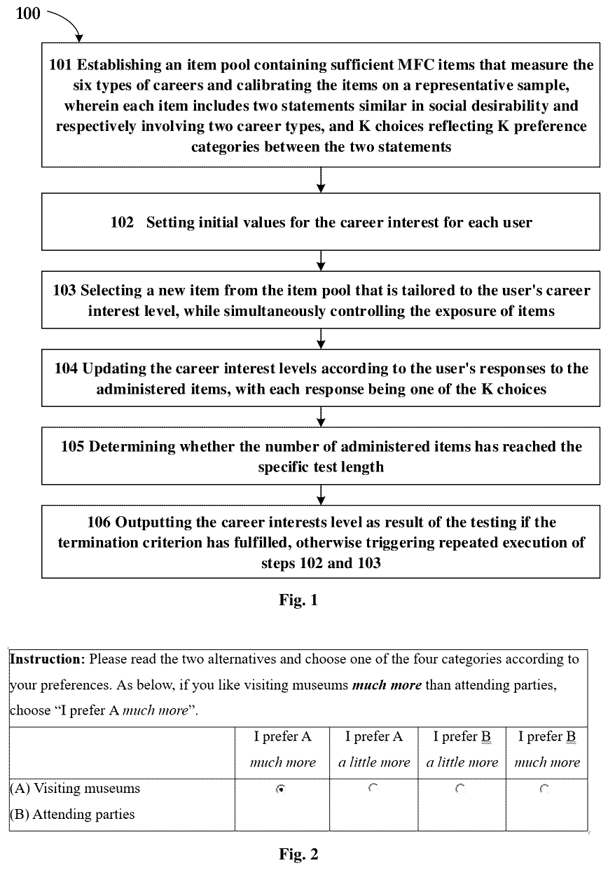

A flowchart of a method 100 for ipsative assessment of a user's career interest level is shown in FIG. 1, wherein the career interest level consists of individual interest degrees of the user for multiple career types. The method 100 comprises the following steps: a step 101 of establishing an item pool containing several hundred of high-quality MFC items that measure the six types of careers and calibrating the items on a representative sample of users to determine the attractiveness of these careers, wherein each MFC item includes two statements similar in social desirability and respectively involving two career types, and K choices reflecting K preference categories between the two statements; a step 102 of setting the entry level (i.e., initial values) of the career interest to 0 for every user to start the CAT administration; a step of 103 of selecting a new item from the item pool based on the career interest level, while simultaneously controlling the exposure of items; a step 104 of updating the career interest level according to the user's responses to the selected item in step 103, wherein each response being one of the K choices; a step 105 of determining whether the number of the administered items has reached a specific test length; and a step 106 of outputting the career interest level as result of the assessment if the termination criterion in step 105 has reached, otherwise triggering repeated execution of steps 103 and 104.

Now, specific embodiments and examples will be described in connection with an exemplary assessment system developed by the inventors of the present disclosure. The exemplary assessment system, referred to as the IHCI-CAT system thereafter, is an online Computerized Adaptive Testing (CAT) system that performs ipsative Holland Career Interest (IHCI) assessment. The IHCI-CAT system enables individuals to efficiently and conveniently assess their career interests online, and it can be accessed at http://hkumatlab.testserverhk.com/, but only can used by internal workers at present for further development and improvement. It can be understood that, although the exemplary system is related to an IHCI assessment, the examples/embodiments according to the present disclosure can be also applied to any other career interest assessments that use MFC items.

As described above, the career interest level consists of a user's interest degrees on multiple career types. For example, in the IHCI-CAT system, a user's career interest level comprises of interest degrees on six career types: Realistic (R), Investigative (I), Artistic (A), Social (S), Enterprising (E), and Conventional (C).

In addition, as described above, the inventors of the present disclosure find that Liker-type items in the existing systems are vulnerable to response biases. For example, a Liker-type item in the classic Holland Career Interest inventory would read as: “How much do you like the activity of attending parties on a 5-point rating scale (e.g., not at all, very little, a little, quite a lot, a great deal)?”. When such an item is used in important settings like pre-employment screening, the candidates are very likely to provide false or socially desirable responses, rather than genuine ones based on their actual interests, in order to enhance their chances of getting the job. This issue is well known as social-desirability bias.

In contrast, the MFC items proposed by the inventors of the present disclosure include two statements similar in social desirability and respectively involving two career types. Because the two statements in an MFC item have comparable levels of social desirability, it can help reduce the potential for the user to be “fake good.” Moreover, each MFC item includes K choices reflecting K preference categories between the two statements, and the user is requested to choose one of the K choices as a response.

For illustration, an example MFC item is shown in FIG. 2. The two statements included in the example item are “Visiting museums” and “Attending parties,” which are similar in social desirability but measure two different career types, respectively. In particular, the first statement “Visiting museums” measures the career type Social, and the second statement “Attending parties” measures the career type Artistic. In other words, the two statements measure the career interest level from different dimensions (i.e., types), which reflects the “multidimensional” nature in the multidimensional forced-choice (MFC) format of the item.

FIG. 2 also shows that the example item includes four choices: “I prefer A much more,” “I prefer A a little more,” “I prefer B a little more,” and “I prefer B much more.” These choices reflect four different preference categories (or four different intensities of preference) between the two statements (i.e., the number K is 4 in this example). The user is asked to respond to the item by selecting one of the four choices, which reflects the “forced-choice” nature in the multidimensional forced-choice (MFC) format of the item.

It also can be seen from FIG. 2 that the example MFC item includes an instruction “Please read the two alternatives and choose one of the four categories according to your preferences. As below, if you like visiting museums much more than attending parties, choose “I prefer A much more”” to guide the user on how to respond to the item. It can be understood that, the instruction is an optional component of the MFC item, and it may be presented to the user before the item administration, in the first item only, or in each item (with some minor adaptive modifications). The solution of the present disclosure has no restriction in this regard.

CAT technology requires a well-designed item pool containing a large number of (e.g., several hundred) high-quality items. According to the present disclosure, the item pool for the IHCI-CAT system consists of 540 MFC items with four choices, like the one shown in FIG. 2. The item pool is understood to be subject to change over time. For example, new items may be added, over-exposed items removed, or outdated items replaced with more appropriate ones.

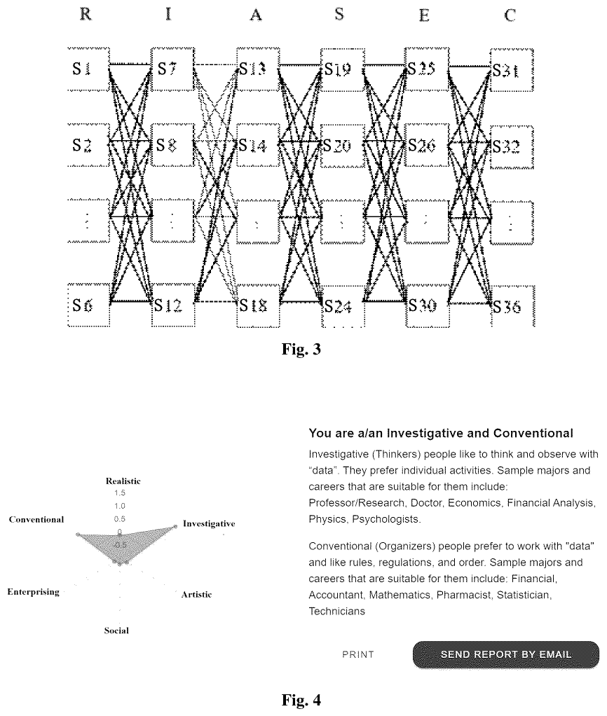

An example formation of the item pool is illustrated in FIG. 3. In the example of FIG. 3, the Realistic (R) type is measured by S1 to S6, the Investigative (I) type by S7 to S12, the Artistic (A) type by S13 to S18, the Social (S) type by S19 to S24, the Enterprising (E) type by S25 to S30, and the Conventional (C) type by S31 to S36. Each MFC item in the item pool is formed by pairing statements from two different career types. For example, {S1, S7}, {S1, S8}, . . . , {S1, S12} represent MFC items that pair the first statement of the R type with the six statements of the I type, respectively; {S1, S13}, {S1, S14}, . . . , {S1, S18} represent MFC items that pair the first statements of the R type with the six statements of the A type, respectively, and so on.

As such, the item pool includes all combinations of any two career types, as indicated by the lines connecting all six career types in FIG. 3. In total, there are

$$540 [ = {6}^{2} \times ( \begin{matrix}6 \\ 2\end{matrix} ) ] MFC$$

items in the item pool for the present disclosure. Though each career type in FIG. 3 is measured by six statements, the present disclosure does not restrict the number of statements per career type, nor does it require the same number of statements for each career type.

Among the 540 MFC items, each career type is measured by or involved in 180 MFC items. For example, the R type is measured by items that pair R with I, A, S, E, and C. As mentioned above, each career type has six different statements. Hence, pairing R with I results in 36 MFC items, pairing R with A results in another 36 items, and so on.

Since an individual statement may be presented to a user multiple times, the user may be affected by sequence effects. The IHCI-CAT system implements a counterbalancing method to control these effects. For example, suppose S1 is paired with S8 in item 1 and with S14 in item 2. Hence, S1 appears twice. To avoid sequence effects, item 1 is presented as {S1, S8} with S1 as the first statement, while item 2 is presented as {S14, S1} with S1 as the second statement.

CAT technology assumes that the parameters of items in the item pool are known. Therefore, in an embodiment, the method comprises a step of calibrating item parameters for items in the item pool using an item response theory (IRT) model. According to the present disclosure, the item parameters in the IHCI-CAT system were calibrated e.g., with responses collected from approximately 300 Hong Kong college students using e.g., the IRT model developed by Qiu and her colleagues for the MFC items (please see the paper “ITEM RESPONSE THEORY MODELS FOR POLYTOMOUS MULTIDIMENSIONAL FORCED-CHOICE ITEMS TO MEASURE CONSTRUCT DIFFERENTIATION” by Qiu, X.-L., de la Torre, J., Wang, Y.-G., and Wu, J., published in Educational Measurement: Issues and Practice in 2024, accessible at https://doi.org/10.1111/emip.12621, referred to as “Qiu et al., 2024” for short in the following). The item parameter estimates from the model represent the utility or attractiveness of the statements. Hence, which career activities or career types are more appealing to users could be evaluated.

In an embodiment, the method comprises a step of setting the entry level (i.e., initial values) of the career interest for every user to before the item administration. According to the present disclosure, the initial values of all six career interests are set to 0. It is understood that the initial values do not necessarily need to be 0 or to be the same for the six career interests. However, they are typically set to 0 in practice.

During the administration of a CAT, a new item will be selected from the item pool and presented to the user after a previously selected item is administered. According to the solution of the present disclosure, the item selection is primarily based on the career interest level, either with initial values of zero for the six career types at the beginning of the assessment or updated career interests level based on the user's response to a previously selected item. Thus, in the solution of the present disclosure, the items administered to each user are different, rather than fixed as in existing systems. Selecting the next item based on the career interest level ensures the assessment is tailored to each user's proficiency level, thereby achieving adaptability.

In an embodiment, a criterion that reflects the level of career interests is used for selecting new items. The statistical information of an item, which indicates the amount of information it provides regarding career interest levels, serves as a natural criterion for this purpose. In general, the more statistical information an item provides, the more accurate the estimation of the career interest level from the item will be. It is understood that many indices can represent the statistical information of an item, such as Fisher Information (FI), Shannon Information, Kullback-Leibler Divergence, Akaike Information Criterion, Bayesian Information Criterion, and Entropy. Those skilled in the art may use one or more of these statistical quantities to calculate the statistical information of the items, according to the specific requirements and software/hardware limitations of the scenario where the solution of the present disclosure is applied. The solution of the present disclosure imposes no restrictions in this regard.

In an embodiment, item exposure control is an important issue in item selection because it is related to effectively use the item pool, to prevent over-exposure or potential leakage of items, and to ensures the security of the testing process. The solution of the present disclosure adopts a method which combines a statistical information component and a random component to control item exposure. These two components contribute to different stages of testing.

In the early stage of testing, when the user's career interest is not yet clear, the importance of information component may be set relatively low, while that of random component may be set relatively high. Especially for the first item, when the user's career interest levels in the six career types are unknown, the item is selected randomly. This allows the testing system to explore the user's potential career interests across a broader range.

As the assessment progresses, the user may lose motivation or feel fatigued. Moreover, since the user has responded to a few items, their career interest level becomes clearer. Hence, in the later stage of the assessment, the importance of information component may be gradually increased, and that of random component may be gradually decreased, improving the chance of selecting items that can provide more information about the user's career interest.

In summary, in the example IHCI-CAT system, as the test progresses, the influence of random component on item selection is reduced and the importance of item information is increasing more prominent. The random component enables a more effective usage of the item pool, and statistical information component ensures the estimation accuracy of the career interest level. Combining both components facilitates a good balance between item pool usage and the accuracy of career interest level estimation.

In an embodiment, the item selection with exposure control is executed by utilizing a function ƒᵥ defined as:

$${f}_{v} = ( 1 - \frac{l}{T} ) \times {R}_{v} + \frac{l}{T} \times det ( {I}_{v} ) ,$$

where l is the number of the administered item(s); T is the number of items that each user will respond to (i.e., the specific test length); v is a vector containing the identifiers of unused items upon current administration in the item pool; det(Iᵥ) represents a vector of the determinants of the FI matrix for each unselected items in v. This is calculated as the negative of expected value of the second derivative of logarithm of probability, using the updated career interest level, item parameters of each item, and the IRT model developed by Qiu et al., 2024; Rᵥ represents a vector of random numbers generated from the uniform distribution [0, max{det(Iᵥ)}] for each unselected item, where max( ) denotes the maximum value. Here,

$$( 1 - \frac{l}{T} ) and \frac{l}{T}$$

can be treated as the weights for random and information components, respectively. An item l′ is selected if it maximizes ƒᵥ:

$${l}^{′} ≡ arg {max}_{{l}^{′}} \{ {f}_{v} , {l}^{′} ∈ v \} .$$

How the function ƒᵥ work may be better understood by observing its application in the exemplary IHCI-CAT system. In the IHCI-CAT system, the test length is fixed at 36, meaning every user will respond to 36 items. Therefore, in the function ƒᵥ, T=36. When a user starts the testing in the IHCI-CAT system (and their career interests in the six career types are initialized to zero), no item has been selected yet (i.e., l=0). Replacing the values of l and T to the function ƒᵥ above, it becomes

$${f}_{v} = ( 1 - \frac{0}{36} ) \times {R}_{v} + \frac{0}{36} \times det ( {I}_{v} ) = {R}_{v} .$$

Hence, the IHCI-CAT system will select the item which has the maximum value of Rᵥ as the first item for the user. Since the selection relies solely on randomly generated numbers, it is equivalent to randomly selecting the item from the item pool. With the first item administered, the user's career interests level are updated.

Next, the second item is to be selected. In this case, one item has already been selected (i.e., l=1). Therefore,

$${f}_{v} = \frac{35}{36} \times {R}_{v} + \frac{1}{36} \times det ( {I}_{v} ) .$$

The IHCI-CAT system will generate another set of random numbers for Rᵥ and compute the determinant of FT for each item based on the updated career interest level. With the new Rᵥ and det(Iᵥ), the value of ƒᵥ are recalculated and the IHCI-CAT system selects the item which has the maximum value of ƒᵥ as the second item for the user. It can be found that the weight for random component decreases from 1 to

$$\frac{35}{36}$$

while the weight for the information component increases from 0 to

$$\frac{1}{36} .$$

The CAT proceeds until the last item is to be selected (i.e., l=35) where the values of function are computed as

$${f}_{v} = \frac{1}{36} \times {R}_{v} + \frac{35}{36} \times det ( {I}_{v} ) .$$

Again, the item which has the maximum value of ƒᵥ will be selected as the last item for the user.

Therefore, by utilizing the ƒᵥ function for item selection, the IHCI-CAT system places more weight on random component, resulting in the selection of less informative items in the early stage of the assessment. As the testing progresses, the IHCI-CAT system gradually prioritizes more informative items to enhance the accuracy of assessing career interest levels.

In an embodiment, the method further comprises controlling the exposure of statements by removing items associated with a statement from the item pool according to a predetermined criterion. Specifically, during each administration of items, the number of times each statement is presented to the user is recorded and counted. Once a statement has been presented to the user a predetermined maximum number of times (e.g., 7 times in the IHCI-CAT system), all items associated with that statement are removed from the item pool and become unavailable to the user. It is important to note that the removed items are only inaccessible to the user who is currently taking the assessment; they remain available for other users.

After the user makes a response to the selected item, the career interest level will be updated according to the response of the user. It can be understood that, persons skilled in the art will conceive of many algorithms to update the career interest level according to the response of the user, and the solution of the present disclosure has no restriction in this regard.

In an embodiment, the updating includes updating the career interest level using a Newton-Raphson procedure as follows:

$${\hat{θ}}_{l + 1} = {\hat{θ}}_{l} - \{ {[ J ( θ ) ]}^{- 1} \times \frac{\partial }{\partial θ} ln L ( {\hat{θ}}_{l} \vert x ) \} ,$$

where l is the number of the administered item(s), θ is the estimates of six career interests; \hat{θ}ₗ is the provisional θ estimate from the l administered items, \hat{θ}ₗ₊₁ is the updated θ estimate. Besides,

$$\frac{\partial }{\partial θ} ln L ( {\hat{θ}}_{l} \vert x )$$

and

$$J ( θ ) = \frac{{\partial }^{2}}{\partial θ \partial {θ}^{′}} ln f ( θ \vert x )$$

are the first and second derivatives of the natural logarithm of the posterior density function based on the response vector x which can be calculated as

$$\frac{\partial }{\partial θ} ln f ( θ \vert x ) = {\sum }_{k = 0}^{J - 1} {v}_{k} ( k - {\sum }_{k = 0}^{J - 1} k {P}_{k} ) - \frac{\partial }{\partial θ} [ {( θ - μ )}^{′} ] {Φ}^{- 1} ( θ - μ ) ,$$

$$and$$

$$\frac{{\partial }^{2}}{\partial θ \partial {θ}^{′}} ln f ( θ \vert x ) = - {\sum }_{k = 0}^{J - 1} {v}_{k} ( {\sum }_{k = 0}^{J - 1} {k}^{2} {P}_{k} - {( {\sum }_{k = 0}^{J - 1} k {P}_{k} )}^{2} ) - {Φ}^{- 1} ,$$

respectively, where Pₖ is the probability of selecting category k (k=0, 1, 2, . . . , K), vₖ is the total score (summed score) for the category k, and μ and Φ are the mean vetor and the variance-covariance matrix, respectively, of the multivariate normal distribution for θ. The procedure is described in a paper “COMPUTERIZED ADAPTIVE TESTING FOR IPSATIVE TESTS WITH MULTIDIMENSIONAL PAIRWISE-COMPARISON ITEMS: ALGORITHM DEVELOPMENT AND APPLICATIONS” by Qiu, X.-L., de la Torre, J., Ro, S., & Wang, W.-C., which was published in Applied Psychological Measurement, 46(4), 255-272, in 2022, can be accessed at https://doi.org/10.1177/01466216221084209, and referred to as “Qiu et al., 2022” for short in the following

After the career interest level is updated, a determination is made as to whether the testing should be terminated according to the predefined criterion. If the criterion is fulfilled, the method terminates the testing and outputs the career interest levels for the user. Otherwise, steps 103 and 104 in FIG. 1 are repeatedly executed. It should be understood that different criteria can be used to terminate the testing, and the solution of the present disclosure imposes no restrictions in this regard.

The exemplary IHCI-CAT system uses a specific test length of 36 items as the termination criterion. Hence, the IHCI-CAT system terminates the assessment once the user has responded to 36 items. It should be understood that using 36 items is a choice based on observations of existing systems, and the IHCI-CAT system allows for different numbers as the criterion to terminate the testing. In the present disclosure, item selection primarily adapts to the user's career interest level, resulting in a unique set of 36 items administered to each user. It should be understood the 36 items for each user may not be evenly divided among the six career types. For example, the 36 items a user administers may comprise of 5, 6, 8, 7, 6, and 4 items measuring types R, I, A, E, S, and C, respectively. Meanwhile, the number of items for each type is unlikely to vary significantly because the random component in function ƒᵥ and the exposure control method in item selection increase the coverage of career types, as shown in Qiu et al., 2022.

After the testing is terminated, the IHCI-CAT system provides the final estimate of the career interest levels for the user in a report, as shown in FIG. 4. This report features a radar chart depicting the career interest levels across the six career interest categories, accompanied by recommendations for careers and occupations that match the user's interests. Additionally, the IHCI-CAT system offers the flexibility for the user to save, print, or email the report directly.

In an embodiment, the career interest level refers to levels of the Holland Career Interests which include the following six career types: Realistic (R), Investigative (I), Artistic (A), Social (S), Enterprising (E), and Conventional (C). For instance, the IHCI-CAT system conducts an ipsative assessment of the levels of Holland Career Interest, as described above.

In an embodiment, the initial career interest levels are used for every user when the system starts. For example, in the IHCI-CAT system, when each user starts the testing, their six career interests are set to 0, as described above.

In an embodiment, the assessment is conducted using an online Computerized Adaptive Testing (CAT) approach, such as the IHCI-CAT system.

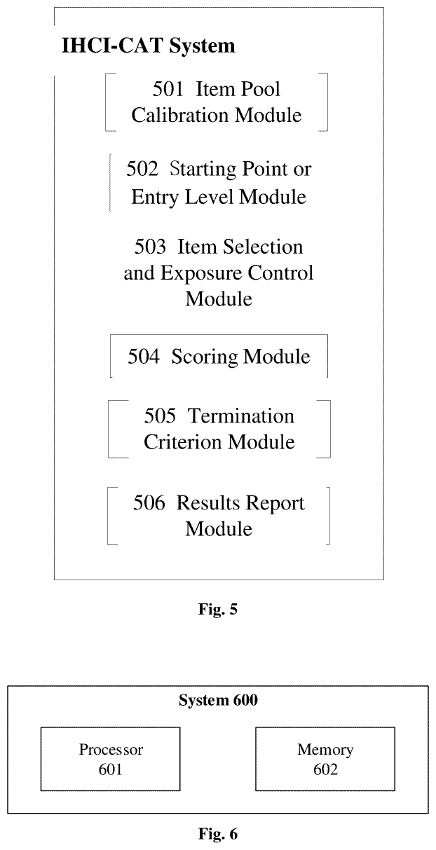

FIG. 5 illustrates a schematic block diagram of the exemplary IHCI-CAT system according to the present disclosure. The IHCI-CAT system comprises: an item pool calibration module 501, for building an item pool and calibrating parameters of all items on a representative sample of users using the IRT model; a starting point or entry level module 502, for providing initial values of career interest level for each user before the item administration; an item selection and exposure control module 503, for selecting new items from an item pool that are tailored to the career interest level and for controlling item exposure; a scoring module 504, for updating the career interest level according to the user's response to the selected item; and a termination criterion module 505, for determining whether the number of the administered items has reached a specific test length, and outputting the career interest level as result of the assessment if the termination criterion is met, otherwise triggering repeatedly execution of operations of the modules 503 and 504. The IHCI-CAT system may optionally comprise a results report module 506 for reporting the result the assessment.

It can be understood that the construction of the IHCI-CAT system in FIG. 5 is just an example with the primary and necessary modules to carry out the adaptive assessment of career interests. A system according to the present disclosure may be implemented with more or less modules than those shown in FIG. 5 to perform additional operations. In addition, a system according to the present disclosure may comprise a single module configured to perform two or more operations, or separate modules for each separate operation. Moreover, the modules may be implemented in hardware, firmware, software, or any combination thereof.

It is understood that blocks of the block diagram and/or flowchart illustration, and combinations of blocks in the block diagram and/or flowchart illustration, may be implemented by computer program instructions. These computer program instructions may be provided to a processor of a general-purpose computer, special-purpose computer, and/or other programmable data processing apparatus to produce a machine, such that the instructions, which execute via the processor of the computer and/or other programmable data processing apparatus, create means for implementing the functions/acts specified in the block diagram and/or flowchart block or blocks.

It is also to be understood that the functions/acts noted in the blocks of the flowchart may occur out of the order noted in the operational illustrations. For example, two blocks shown in succession may in fact be executed substantially concurrently or the blocks may sometimes be executed in the reverse order, depending upon the functionality/acts involved. Although some of the diagrams may include arrows on communication paths to show a primary direction of communication, it is to be understood that communication may occur in the opposite direction to the depicted arrows.

Furthermore, the solution of the present disclosure may take the form of a computer program on a memory having computer-usable or computer-readable program code embodied in the medium for use by or in connection with an instruction execution system. In the context of this document, a memory may be any medium that may contain, store, or is adapted to communicate the program for use by or in connection with the instruction execution system, apparatus, or device.

Therefore, the present disclosure also provides a system 600 including a processor 601 and a memory 602, as shown in FIG. 6. In the system 600, the memory 602 stores instructions that when executed by the processor 601 cause the system 600 to perform the method described above with the embodiments.

The present disclosure also provides a machine readable medium (not illustrated) having stored thereon instructions that when executed on a system cause the system to perform the method described with the above embodiments.

Moreover, the system according to the present disclosure can be implemented as a network element on a dedicated hardware, as a software instance or a firmware running on a hardware, as a virtualized function instantiated on an appropriate platform (e.g., on a cloud infrastructure), or as any combination thereof.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above-described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

What is claimed is:

1. A method for adaptively assess users' career interests level using ipsative items, comprising the following steps:
establishing an item pool with several hundred of high-quality MFC items and calibrating the parameters of items; wherein each item includes two statements similar in social desirability and respectively involving two career types, and K choices reflecting K preference categories between the two statements;
setting initial values for the career interest for every user before item administration;
selecting a new item from the item pool that is tailored to the user's career interest level, while simultaneously controlling the exposure of items
updating the career interest level according to the user's response to the selected item, wherein the response specifies one of the K choices;
determining whether the number of the administered items has reached the specific test length; and
outputting the career interest level as result of the assessment if the termination criterion is fulfilled, otherwise triggering repeated execution of steps 3 and 4.

2. The method of claim 1, comprising a step of building an item pool and calibrating item parameters of all items on a representative sample of users to determine the attractiveness of these careers using an item response theory (IRT) model.

3. The method of claim 1, wherein the initial values of career interests level are set to zero for every user before item administration.

4. The method of claim 1, wherein the selection includes:
selecting the new item based on a function that combines with a random component and a statistical information component, wherein as the test progresses, the influence of random component on item selection is reduced and the importance of information component is increasing more prominent.

5. The method of claim 4, wherein the selection is executed by utilizing a function ƒᵥ defined as:
$${f}_{v} = ( 1 - \frac{l}{T} ) \times {R}_{v} + \frac{l}{T} \times det ( {I}_{v} ) ,$$
where l is the number of the administered item(s), T is the specific test length, v is a vector containing the identifiers of unselected items upon the current administration in the item pool, det(Iᵥ) is the determinant of the Fish Information (FI) matrix for the unselected items, Rᵥ is a vector of random numbers generated from the uniform distribution [0, max{det(Iᵥ)}] for each unselected item, wherein the determinant of the FI matrix of an item is calculated using the updated career interest level and item parameters of the item.

6. The method of claim 4, further comprising:
removing all items associated with a statement from the item pool, if the number of times that the statement has been presented to a user has reached a predetermined maximum number.

7. The method of claim 1, wherein the updating includes updating the career interest level using a Newton-Raphson procedure as follows:
$${\hat{θ}}_{l + 1} = {\hat{θ}}_{l} - \{ {[ J ( θ ) ]}^{- 1} \times \frac{\partial }{\partial θ} ln L ( {\hat{θ}}_{l} \vert x ) \} ,$$
where θ is the vector of career interests estimates; \hat{θ}ₗ is the provisional θ estimate from the l administered items, \hat{θ}ₗ₊₁ is the updated θ estimate. Besides,
$$\frac{\partial }{\partial θ} ln L ( {\hat{θ}}_{l} \vert x )$$
and
$$J ( θ ) = \frac{{\partial }^{2}}{\partial θ \partial {θ}^{′}} ln f ( θ \vert x )$$
are the first and second derivatives of the natural logarithm of the posterior density function based on the response vector x which can be calculated as
$$\frac{\partial }{\partial θ} ln f ( θ \vert x ) = {\sum }_{k = 0}^{J - 1} {v}_{k} ( k - {\sum }_{k = 0}^{J - 1} k {P}_{k} ) - \frac{\partial }{\partial θ} [ {( θ - μ )}^{′} ] {Φ}^{- 1} ( θ - μ ) ,$$
$$and$$
$$\frac{{\partial }^{2}}{\partial θ \partial {θ}^{′}} ln f ( θ \vert x ) = - {\sum }_{k = 0}^{J - 1} {v}_{k} ( {\sum }_{k = 0}^{J - 1} {k}^{2} {P}_{k} - {( {\sum }_{k = 0}^{J - 1} k {P}_{k} )}^{2} ) - {Φ}^{- 1} ,$$
respectively, where Pₖ is the probability of selecting the category k (k=0, 1, 2, . . . , K), vₖ is the total score (summed score) for the category k, and μ and Φ are the mean vetor and the variance-covariance matrix, respectively, of the multivariate normal distribution for θ.

8. The method of claim 1, wherein the career interest level refers to degree of Holland Career Interest for the following six career types: Realistic (R), Investigative (I), Artistic (A), Social (S), Enterprising (E), and Conventional (C).

9. The method of claim 1, wherein the assessment is an online Computerized Adaptive Testing (CAT) assessment.

10. An online adaptive testing system for the ipsative assessment of users' career interest levels, including:
a processor; and
a memory having stored instructions which, when executed by the processor, cause the system to perform the method of claim 1.
